(19) United States
(12) Patent Application Publication
(10) Pub. No.: US 2003/0035067 A1
(43) Pub. Date: Feb. 20, 2003

(54) Moving image correction system and moving image correction method

(76) Inventor: Kenji Masaki, Nagaokakyo-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/188,954

(22) Filed: Jul. 5, 2002

(30) Foreign Application Priority Data
Jul. 10, 2001 (JP) 2001-209299

(51) Int. Cl. H04N 5/213

(52) U.S. Cl. 348/607; 382/254; 348/649

(57) ABSTRACT

In a moving image correction system including a client and server that are mutually connected such that data transmission is enabled therebetween over a network, the client analyzes the changes over time in the average value of the moving image that comprises the subject of correction and sends the analysis results to the server, and the server receives the analysis results sent from the client and corrects the data sent from the client based on the analysis results in prescribed units. The server can efficiently perform correction of the moving image by using the analysis results furnished by the client.

### CROSS-REFERENCE TO RELATED APPLICATIONS

This application is based on application No. 2001-209299 filed in Japan, the contents of which is hereby incorporated by reference.

### BACKGROUND OF THE INVENTION

1. Field of the Invention

The present invention pertains to a client/server system that performs correction of moving images (hereinafter also called a ‘moving image correction system’).

2. Description of the Related Art

The above client/server system that performs correction of still images handles images that are each independent still images, and the data for a still image is itself much smaller than data for a moving image. There has been a demand that moving images be corrected by a client/server system in the same way that still images are corrected.

One possible way to accomplish this is to send moving images from a client to the server over a network, and to send them back to the client over the network as corrected moving images after the server carries out analysis of the series of moving images and performs prescribed correction operations, as in the case of still images. However, such a moving image correction system has the problem that because generally extremely large moving image data is transferred from the client to the server, which then performs analysis and correction of the series of moving images, the server resources are easily wasted and the server becomes excessively burdened.

### OBJECTS AND SUMMARY

With the foregoing problem in view, an object of the present invention is to provide a moving image correction system capable of effectively correcting moving images.

These and other objects are attained by providing a moving image correction system, a moving image correction method and a moving image correction program having the following construction.

In order to resolve the problem above, a first aspect of the invention is a moving image correction system that includes a client and a server that are mutually connected such that data communication is enabled therebetween over a network and in which the server processes a moving image sent from the client, wherein the client has analyzing means that analyses a prescribed characteristic of the moving image to be corrected that changes over time, analysis result sending means that sends the results of the analysis performed by the analyzing means to the server over the network, and moving image sending means that sends the moving image to the server over the network, and the server has receiving means that receives the analysis results and the moving image sent from the client and correcting means that corrects the moving image sent from the client based on the analysis results.

In the moving image correction system described above, the server can perform correction in accordance with the analysis results obtained by the client, and therefore correction can be effectively performed while maintaining the continuity of the moving image.

The first aspect of the invention is the moving image correction system described above, wherein the prescribed characteristic that changes over time with regard to the moving image analyzed by the client is value, such that the changes in value over time are analyzed, and the correcting means performs correction such that the value values obtained as a result of the analysis are essentially maintained.

The first aspect of the invention is the moving image correction system described above, wherein the prescribed characteristic that changes over time with regard to the moving image analyzed by the client is chroma, such that the changes over time in chroma are analyzed, and the correcting means performs correction such that the chroma values obtained as a result of the analysis are essentially maintained.

The first aspect of the invention is the moving image correction system described above, wherein the prescribed characteristic that changes over time with regard to the moving image analyzed by the client is hue, such that the changes over time in hue are analyzed, and the correcting means performs correction such that the hue values obtained as a result of the analysis are essentially maintained.

A second aspect of the present invention is programs used in a movie correction system comprising a client and a server that are mutually connected such that data communication is enabled therebetween over a network, wherein the program used by the client computer has an analysis function to perform prescribed analysis of the movie to be corrected, an analysis result sending function to send the analysis results obtained via the analysis function to the server over the network, and a movie sending function to send the movie to the server over the network, and the program used by the server has a receiving function to receive the analysis results and the movie sent from the client and a correcting function to correct the movie received via the receiving function using the analysis results.

Because the programs used in the movie correction system described above enable the client computer to perform analysis of the movie and enable the server to perform correction in accordance with the analysis results furnished by the client, correction can be effectively performed by the server in particular.

In the client program according to the second aspect of the invention, the analysis function includes the analysis of the changes over time in a prescribed characteristic of the movie.

The client program according to the second aspect of the invention further includes a movie dividing function to divide the movie into multiple basic units, and the movie sending function sends the movie as a series of units.

In the server program according to the second aspect of the invention, the analysis results include information regarding the changes over time in a prescribed characteristic of the movie, and the correcting function has an image correction program that corrects the image data such that the characteristic values obtained as a result of the analysis may be maintained.

The server program according to the second aspect of the invention also has a post-correction movie sending function to send the post-correction movie processed via the correcting function to the client over the network.

In the server program according to the second aspect of the invention, the receiving function receives in basic units the movie divided into multiple basic units and sent from the client, and the correcting function individually performs correction of each of the multiple basic units using the analysis results. Through the above construction, more effective processing is enabled.

A third aspect of the invention is a movie correction method for a system that includes a client and a server that are mutually connected such that data communication is enabled therebetween over a network, and has (a) a step in which the client analyzes the movie to be corrected, (b) a step in which the client sends the analysis results obtained in step (a) to the server over the network, (c) a step in which the server receives the analysis results sent in step (b), (d) a step in which the client sends the movie to the server over the network, (e) a step in which the server receives the movie sent from the client, and (f) a step in which the server corrects the received movie based on the analysis results.

In the movie correction method according to the third aspect of the invention, the analysis function that performs analysis in step (a) analyzes the changes over time in a prescribed characteristic of the movie.

In the movie correction method according to the third aspect of the invention, when the movie is sent in step (d), it is sent as a series of multiple basic units into which it is divided.

In the movie correction method according to the third aspect of the invention, the step (d) when the movie is sent, it is sent as a series of multiple basic units into which it is divided.

Because the movie correction method described above enables the client computer to perform analysis of the movie and enables the server to perform correction thereof in accordance with the analysis results furnished by the client, movie correction can be effectively performed. In addition, where the movie is divided and sent in units, the burden on the server can be further reduced, enabling more effective operation. Furthermore, where the changes over time are analyzed, correction can be performed while taking into account the continuity of the movie.

According to a fourth aspect of the invention, the client computer-executed program used in a moving image correction system that includes a client and a server that are mutually connected such that data communication is enabled therebetween over a network, wherein the moving image sent from the client is corrected by the server, has analyzing means that analyzes a prescribed characteristic that changes over time with regard to the moving image to be corrected, analysis result sending means that sends the analysis results obtained by the analyzing means to the server over the network, and moving image sending means that sends the moving image to the server over the network.

In the fourth aspect of the invention, the analyzing means further includes the analysis of the compression/preservation format of the moving image.

In the fourth aspect of the invention, the characteristic that changes over time and is analyzed by the analyzing means is value.

As described above, by having the moving image processed by the client computer in advance, when the moving image is corrected by the server, the burden on the server can be reduced and the moving image can be effectively corrected.

According to a fifth aspect of the invention, the server-executed program used in a moving image correction system that includes a client and a server that are mutually connected such that data communication is enabled therebetween over a network, wherein the moving image sent from the client is corrected by the server, has receiving means that incorporates the characteristic values that correspond to the changes over time analyzed by the client regarding the moving image sent from the client, an image receiving means that incorporates the moving image sent from the client over the network, and a correcting means that corrects the moving image incorporated by the moving image receiving means using the analysis results.

In the fifth aspect of the invention, the incorporated analysis results include information regarding the changes over time in the value of the moving image, and the correcting means corrects the image data such that the value information is essentially maintained.

In the fifth aspect of the invention, the image receiving function incorporates the moving image that is divided into multiple basic units and is sent from the client such that the moving image is incorporated in basic units, and the correcting means individually corrects each of the multiple basic units using the analysis results.

Because the programs used in the moving image correction system described above enable the client computer to perform analysis of the moving image and enable the server to perform correction in accordance with the analysis results obtained by the client, the server can effectively perform correction.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 is a summary drawing showing the construction of a moving image correction system 1 pertaining to a first embodiment of the present invention;

FIG. 2 is a conceptual drawing showing the hardware construction of a client 10 and a server 20;

FIG. 3 is a functional block diagram of the client 10 and the server 20;

FIG. 4 is a flow chart showing the operations of the moving image correction system 1;

FIG. 5 is a drawing to explain the Motion JPEG format;

FIG. 6 is a drawing showing the changes over time in the average value of a moving image MP;

FIG. 7 is a drawing showing one example of the contents of sent data;

FIG. 8 is a drawing showing histograms regarding the three color components (R, G, B) in a prescribed frame;

FIG. 9 is a drawing to explain the construction of a file having the MPEG format; and

FIG. 10 is a drawing showing the changes over time in the average value of the moving image MP.

In the following description, like parts are designated by like reference numbers throughout the several drawings.

### DESCRIPTION OF THE PREFERRED EMBODIMENTS

<1. First Embodiment>

<Summary Description of Construction>

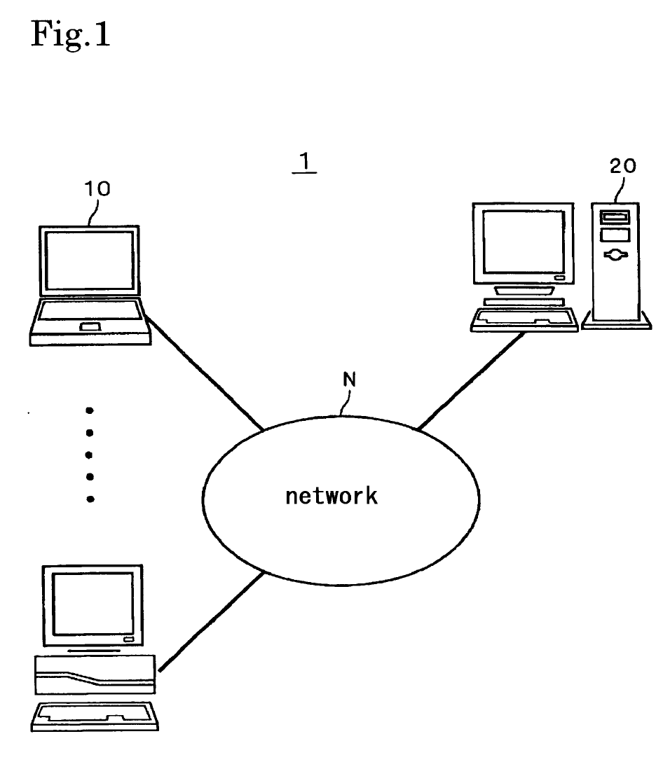

FIG. 1 is a summary drawing showing the construction of a moving image correction system 1 pertaining to a first embodiment of the present invention.

As shown in FIG. 1, this moving image correction system 1 includes multiple clients 10 and a server 20. Each client 10 and the server 20 are mutually connected such that data communication is enabled therebetween over the network N.

Here, ‘network’ refers to a communication network over which data communication is performed, and specifically includes any of the various communication networks comprising electric communication lines (including optical communication lines), such as the Internet, a LAN, a WAN, a CATV or an ICN (inter-community network). An apparatus may be connected to the network at all times using a dedicated line or may be temporarily connected via dial-up connection using telephone lines such as analog lines or digital lines (ISDN). In addition, the transmission method can be based on either the wireless method or the wired method.

This moving image correction system 1 is a client/server system that performs correction of moving images. Specifically, it is a system in which a moving image to be corrected is sent from a client 10 to the server 20 over the network N and the server 20 corrects the moving image and sends it back to the client 10. As described below, analysis of the moving image is carried out by the client 10 beforehand, and the server 20 performs correction using the analysis results.

<Client and Server>

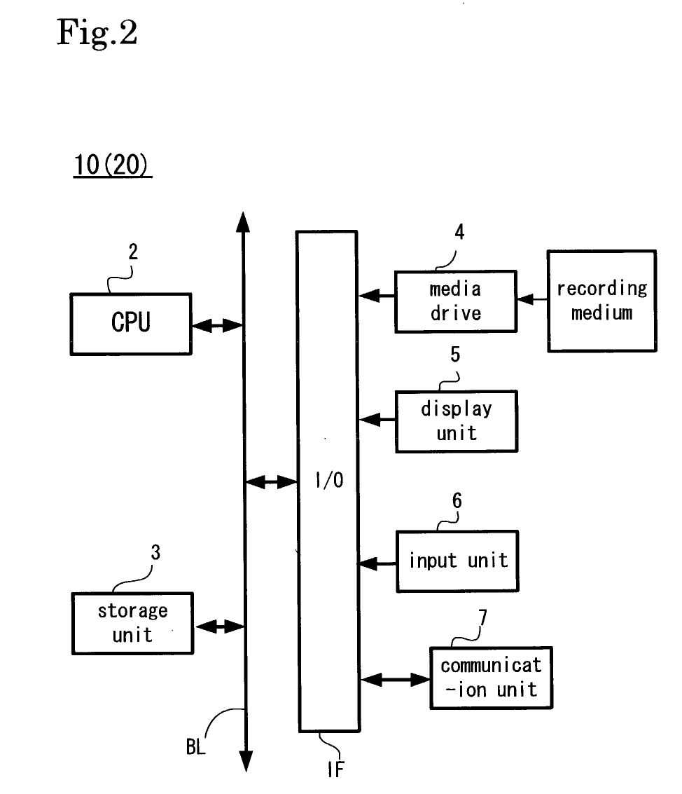

The client 10 will now be described. FIG. 2 is a conceptual drawing showing the hardware construction of the client 10. The client 10 comprises a computer system (hereinafter simply called a ‘computer’) including a CPU 2, a storage unit 3 including a semiconductor memory and a hard disk or the like, a media drive 4 that reads out information from various recording media, a display unit 5 that includes a monitor or the like, an input unit 6 that includes a keyboard and a mouse or the like, and a communication unit 7 that enables communication with other equipment.

The CPU 2 is connected to the storage unit 3, the media drive 4, the display unit 5, the input unit 6, the communication unit 7, etc., via a bus line B L and an I/O interface IF The media drive 4 reads out information recorded on a portable recording medium 9 comprising a CD-ROM, a DVD (digital versatile disk), a flexible disk or other type of medium.

This client 10 functions as a client 10 that implements the various operations described below by reading the software program (hereinafter simply called the ‘program’) recorded on the recording medium 9 and executing the program via the CPU 2. The manner in which the program having the various functions is provided (or distributed) is not limited to a route that uses the recording medium 9, and may be provided (or distributed) to the computer over a network (communication lines) such as a LAN or the Internet, and the communication unit 7.

The server 20 also comprises a computer having the same hardware construction as above. It functions as a server 20 that implements the various operations described below by reading a prescribed program and executing it.

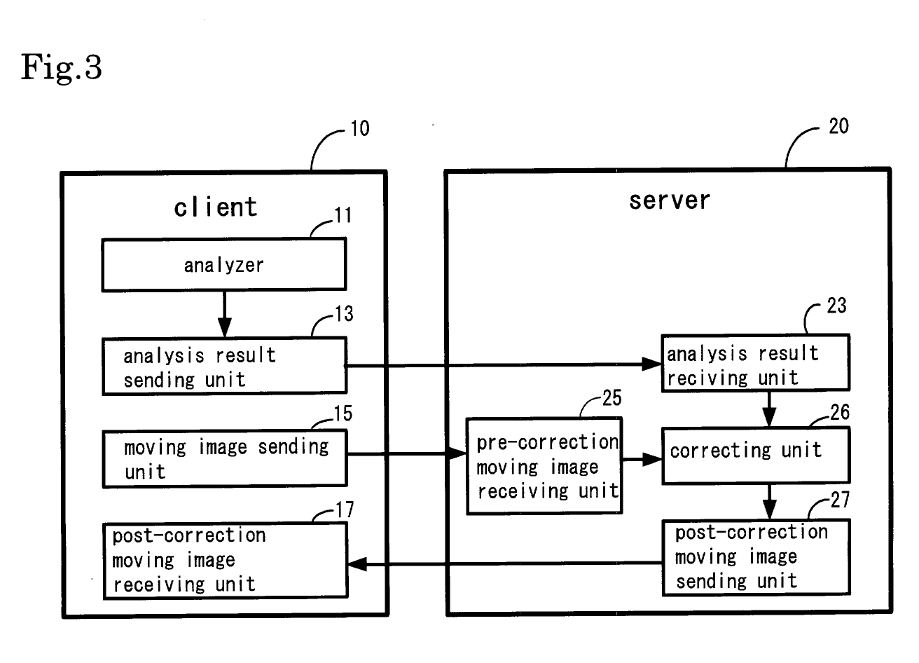

FIG. 3 is a functional block diagram of the client 10 and the server 20. The functions of the client 10 will first be explained with reference to FIG. 3.

The client 10 includes an analyzer 11, an analysis result sending unit 13, a moving image sending unit 15, and a post-correction moving image receiving unit 17.

The analyzer 11 analyzes the moving image to be corrected. More specifically, the analyzer 11 analyzes the data format for the moving image, the changes over time (the changes along the time axis) in a prescribed characteristic (such as the average value, for example) of the moving image, etc.

The analysis result sending unit 13 sends the analysis results obtained by the analyzer 11 to the server 20 over the network N.

The moving image sending unit 15 sends the moving image to the server 20 over the network N. More specifically, the moving image is divided into multiple basic units, which are described below, and these units are sent.

The post-correction moving image receiving unit 17 receives the moving image that has undergone correction as described below.

The functions of the server 20 will now be explained.

The server 20 includes an analysis result receiving unit 23, a pre-correction moving image receiving unit 25, a correcting unit 26, and a post-correction moving image sending unit 27.

The analysis result receiving unit 23 receives the analysis results sent from the analysis result sending unit 13 of the client 10 over the network N. As described above, the analysis results regarding the moving image include information regarding the changes over time in a prescribed characteristic (such as the changes over time in the average value) (this information may hereinafter be referred to as ‘change information’).

The pre-correction moving image receiving unit 25 receives the moving image sent from the moving image sending unit 15 of the client 10.

The correcting unit 26 corrects the moving image sent from the moving image sending unit 15 of the client 10 (i.e., the moving image received by the pre-correction moving image receiving unit 25) based on the analysis results received by the analysis result receiving unit 23. As described below, this correcting unit 26 corrects the moving image based on the change information. Here, the moving image is divided into multiple basic units, and is sent in basic units from the client 10. The correcting unit 26 individually performs correction regarding each of these multiple basic units.

The post-correction moving image sending unit 27 sends the moving image that has undergone correction by the correcting unit 26 (the post-correction moving image) to the client 10 over the network N. Specifically, each individually corrected basic unit is returned to the client 10. Each basic unit of the post-correction moving image thus sent is received by the post-correction moving image receiving unit 17.

<Operations>

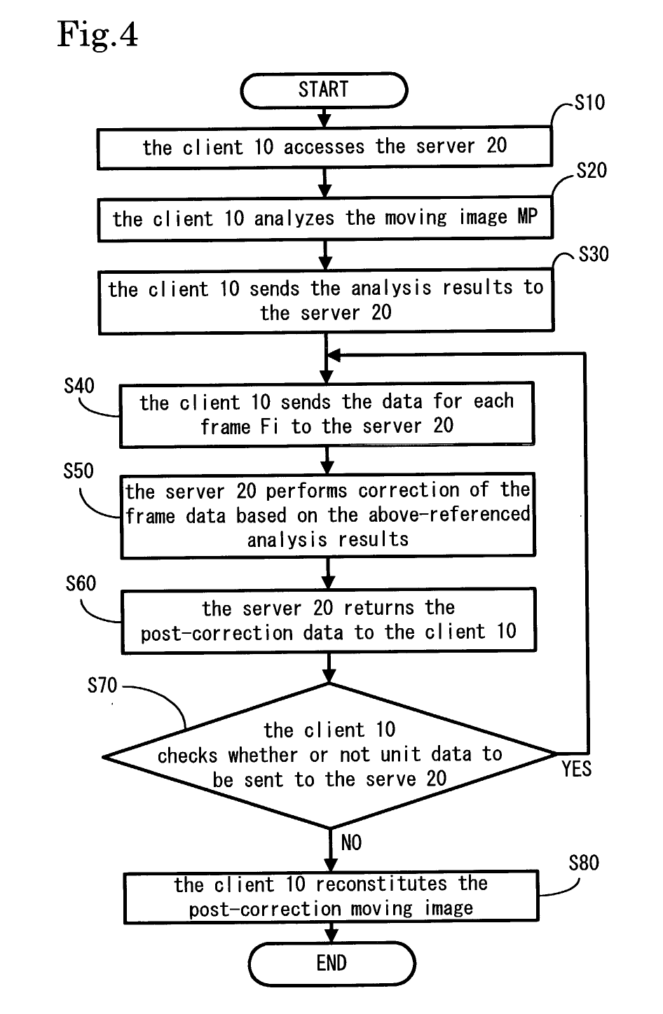

FIG. 4 is a flow chart showing the operations of the moving image correction system 1.

As shown in step S10, the client 10 accesses the server 20. When the user of the client 10 inputs the pre-obtained authorization information (such as a user name or a password), it is determined by the server 20 whether or not the user is a proper user.

When it is determined that the accessing user is a proper user, the server 20 becomes ready to receive commands from that user. Subsequently, the next step S20 is carried out. Where it is determined that the user is not a proper user, the server 20 returns to the client 10 data for display of a prompt for the user to perform user registration via a separate user registration screen. The client 10 displays a display prompting user registration, and determines whether or not the operator (user) of the client 10 has performed user registration.

In step S20, the client 10 analyzes the moving image MP to be corrected. More specifically, the analyzer 11 of the client 10 performs this analysis operation. Here, the following three items are analyzed: (1) the data format of the moving image MP, (2) the changes in the average value of each frame included in the moving image MP (changes over time in the average value), and (3) the number of units into which the moving image MP is divided.

First, the analysis of (1) the data format of the moving image MP will be explained. Specifically, it is determined which format is used for the data format of the moving image MP from among multiple formats such as the Motion JPEG and MPEG formats.

More specifically, the data format of the file is presumed from the file extension that expresses the moving image MP, and it is checked whether or not the presumption was correct by verifying whether or not it is possible to read out that file via the library that corresponds to that data format.

For example, where the extension is ‘avi’, it is presumed that the data file uses the Motion JPEG format. Using the program library that reads out Motion JPEG format files, an attempt is made to read out the file. Where the data file of the moving image MP can be accurately read out as a result, it is confirmed that the data file is a Motion JPEG format file.

Where the extension is ‘mpg’, it is presumed that the data file uses the MPEG format. Using the program library that reads out MPEG format files, an attempt is made to read out the file. Where the data file of the moving image MP can be accurately read out as a result, it is confirmed that the data file is a MPEG format file.

The data format of the moving image MP can be identified in this fashion.

The analysis operation regarding (2) the changes in the average value of each frame included in the moving image MP (the changes over time in the average value) will now be explained. Here, an example in which the data format of the moving image MP is the Motion JPEG format is used.

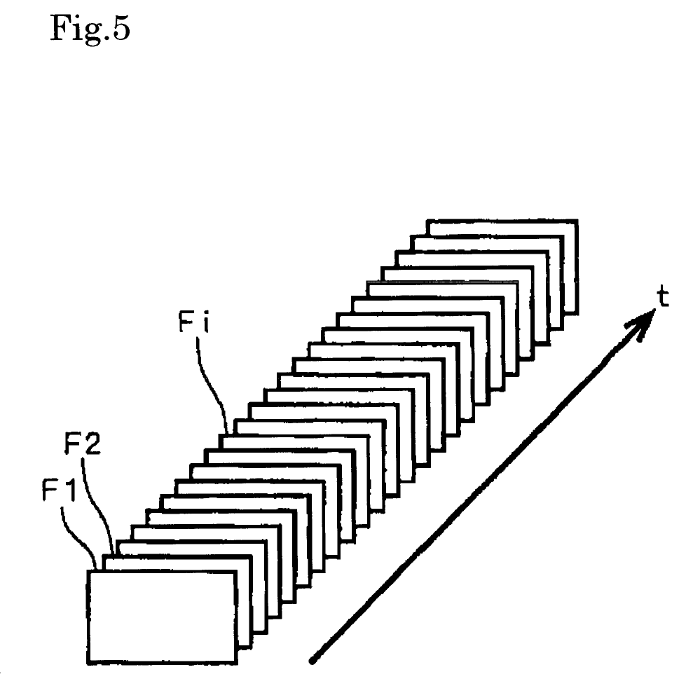

FIG. 5 is a drawing to explain the Motion JPEG format. Where the Motion JPEG format is used, the data has a construction in which each of the continuous multiple still images (hereinafter ‘frames’) Fi (i=1, . . . , M, where M represents the total number of frames) that comprises the moving image is compressed using the JPEG format.

The analyzer 11 calculates the average tone values Ra, Ga and Ba for the three color components (i.e., R (red) component, G (green) component, and B (blue) component) of all pixels included in each frame Fi included in the data having the Motion JPEG format, and seeks the average value Vi for each frame Fi based on the following expression 1.

Vi=Ra·x+Ga·y+Ba·z (1)

Here, x, y and z are prescribed coefficients, and each coefficient x, y and z is established such that the value Vi has a value between 0 through 255 when the values Ra, Ga and Ba have a value between 0 through 255, respectively, for example.

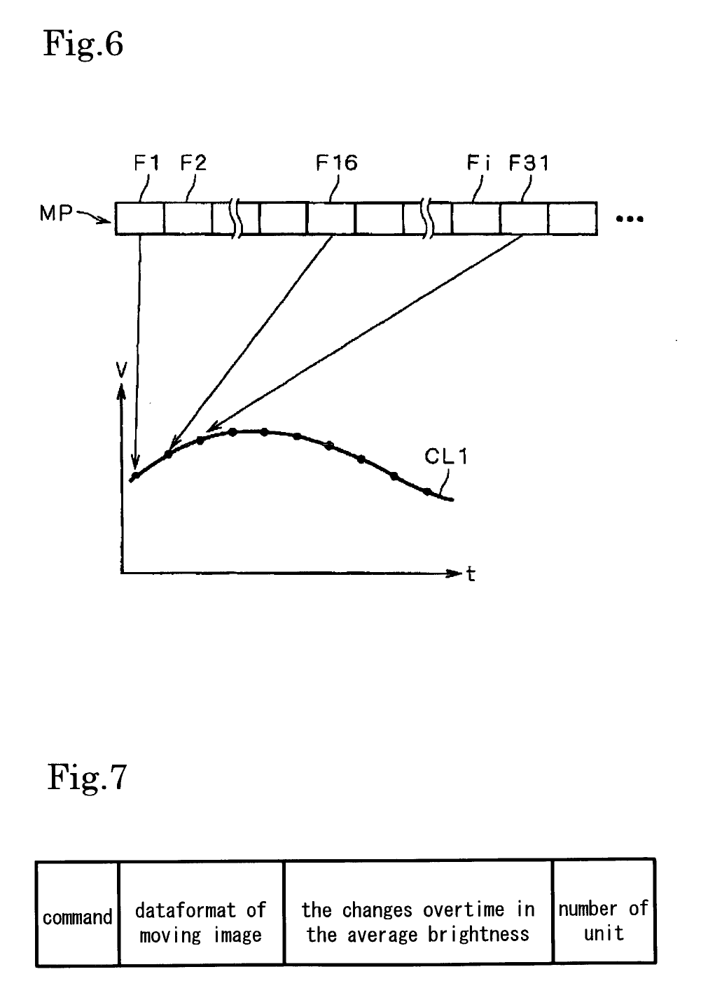

This value Vi may be sought for all frames Fi (i=1, . . . , M), but in order to make the analysis operation efficient by reducing the amount of data, the value Vi is sought for every prescribed number of frames in this embodiment. To put it in a extreme way, the burden on the client 10 is reduced by reducing the number of frames to be analyzed through the thinning of some frames. For example, as shown in FIG. 6, the value Vi is sought regarding every 15th frame, i.e., F1, F16, F31, F46, . . . , and the operation to seek the value Vi is omitted for other frames. As described below, the value Vi is sought via interpolation for the frames as to which the analysis operation to obtain the value Vi is not performed.

The analysis operation regarding (3) the number of units into which the moving image MP is divided will now be explained. The number of units here is the number of units into which the client 10 divides the moving image MP in order to send it in units to the server 20, as described below. In other words, the number of units is determined beforehand in preparation for the sending in units, which is described below. For example, the number obtained by dividing the number of all of the frames M included in the moving image MP by a prescribed number (such as 15) and rounding up the decimal portion can be sought as the number of units.

When the analysis operation described above is completed, the client 10 sends the above analysis results to the server 20 in the next step S30.

FIG. 7 is a drawing showing one example of the contents of the transmission data at this time. This transmission data includes (1) the command, (2) the data format of the moving image, (3) the changes over time in the average value, and (4) the number of units. For example, ‘the command’ is expressed by preset characters, symbols or the like that indicate that this transmission data comprises analysis data, and ‘the data format of the moving image’ is expressed by characters, symbols or the like that express that the data is in the Motion JPEG format. The ‘changes over time in the average value’ are expressed as a row of numbers comprising the frame number (i) and the value Vi corresponding to that frame number, and ‘the number of units’ is expressed as a number that indicates the number of units (n) when the moving image MP is to be sent in units.

The transmission data that includes the analysis results is sent from the analysis result sending unit 13 of the client 10 to the server 20, and is received by the analysis result receiving unit 23 of the server 20. These analysis results are used in the correction operation of step S50.

In steps S40 through S70, such operations as transmission, correction and reply are performed for each unit of data of the moving image MP. In other words, the moving image MP is divided into units of data comprising multiple basic units, and is sent from the client 10 by basic unit. Here, the ‘frame’, which is the smallest unit of the moving image MP, is used as the basic unit. In this moving image unit transmission operation, in order to reduce the amount of transmission data, the sound data is excluded and only the visual image data is deemed the object of unit-based transmission.

In step S40, the client 10 sends the data for each frame Fi of the moving image MP to the server 20. Specifically, it first sends the first frame F1 data.

In the next step S50, the server 20 that receives this frame F1 data performs correction of this frame F1 data based on the above-referenced analysis results. In this embodiment, an operation to adjust the color based on the average value is carried out.

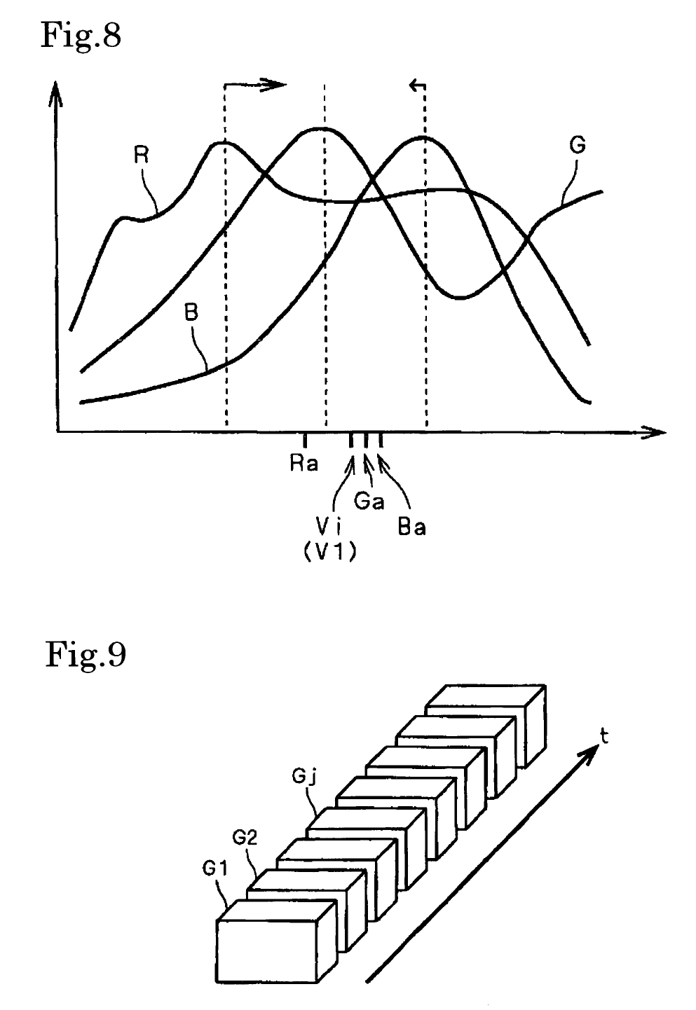

In order to perform color adjustment, a frequency distribution (histogram) regarding the tone values of all pixels in the frame F1 is created for each color component (R, G, B) plane. FIG. 8 is a drawing showing the histograms for the three color component (R, G, B) planes in an overlapping fashion.

This correction process is a process in which the color is adjusted by changing the balance among the color components. However, in order to maintain the overall value at the pre-correction level, the above-referenced analysis results are used. Specifically, the balance among the color components is changed such that the average value Vb of the post-correction frame Fi equals the pre-correction value Vi. Here, the average tone values for the R-component, G-component and B-component of all of the pre-correction pixels will be expressed as Ra, Ga and Ba, and the post-correction R-component, G-component and B-component average tone values will be expressed as Rb, Gb and Bb, respectively. The pre-correction average value will be expressed as Vi and the post-correction average value will be expressed as Vb.

While there are various approaches for the changing of the balance, the method adopted in this embodiment is a method in which, among the pre-correction three color components, the color component having an average tone value closest to the value Vi is not changed, while changes are made to the other two color components. For example, as shown in FIG. 8, where, among the average tone values Ra, Ga and Ba, the value Ga is the closest to the value Vi, no change is made to the G component. In other words, the average tone value Gb for the G component is unchanged after processing, and is equal to the pre-correction value Ga (Gb=Ga). Accordingly, the G-component tone value for each pixel after processing remains unchanged.

Of the remaining two color components, the color component regarding which the difference between the average tone value and the value Vi is larger is changed such that its average tone value equals the value Vi. For example, where ||(Vi−Ra)||>||(Vi−Ba)||, the post-correction average tone value Rb for the R component is made equal to the value Vi, i.e., Rb=Vi. Through this processing, any imbalance in the color components can be corrected. Subsequently, the R-component tone value for each post-correction pixel is changed in accordance with the ratio k1 (=Rb/Ra) between the pre-correction and post-correction average tone values. For example, where k=1.3 and the R-component tone value for one pre-correction pixel is 100, the post-correction R-component tone value for that pixel is calculated as 130. Where the calculated value exceeds the maximum value (such as 255), the tone value is set to be the maximum value. In this case, the post-correction average tone values Rb for all pixels may be re-calculated.

For the remaining color component, the average tone value is adjusted such that the post-correction average value Vb expressed by the following expression 2 equals the pre-correction average value Vi.

Vb=Rb·x+Gb·y+Bb·z (2)

For example, where the remaining color component is the B component, its average tone value Bb is sought via the following expression 3.

$$\begin{matrix}B b = ( V i - R b \cdot x - G b \cdot y ) / z \\ = ( V i - V i \cdot x - G a \cdot y ) / z\end{matrix} \qquad ( 3 )$$

The B-component tone values for each of the post-correction pixels are then changed in accordance with the ratio k2 (=Bb/Ba) between the pre-correction and post-correction average tone values. For example, where k2=0.8 and the B-component tone value for one pre-correction pixel is 100, the post-correction B-component tone value for that pixel is calculated as 80.

The color-component tone values for each pixel are changed such that the values Rb, Gb and Bb are the average tone values for each color component, as described above. In this way, correction is carried out in which the post-correction average value Vb is maintained at the value Vi (V1) while the color of the frame Fi (F1) is changed.

In step S60, the server 20 returns the post-correction data to the client 10.

In step S70, the client 10 checks whether or not unit data (frames) to be sent to the serve 20 still remain. Specifically, the number of frames sent is counted, and the count result is compared with the total number of frames M. Where the number of frames sent is smaller than the value M, i.e., where unit data still remains to be sent, the operations of steps S40, S50 and S60 are repeated. On the other hand, where the number of frames sent equals the value M, i.e., where all unit data has been sent, the routine is ended.

Here, step S40 is returned to assuming that unit data to be sent still remains.

In step S40, the client 10 sends the data for the second frame F2 to the server 20. The server 20 that receives the frame F2 data performs color adjustment based on the above-referenced analysis results in step S50. However, the data sent in step S30 as analysis results does not include data regarding the frame F2 (i.e., the value V2). Therefore, in this case, the value V2 is sought from the data for surrounding units via interpolation. For example, the value V2 can be obtained via linear interpolation using the V1 and V16 data, or it is also acceptable if higher-order interpolation is performed using other values such as V31, V46, etc. Correction is then carried out to change the balance among the color components while ensuring the average value Vb of the post-correction frame F2 is the value V2, in the same manner as described above. Through this processing, it becomes possible to correct the color of the frame F2 while ensuring that the value thereof is a value that lies on the continuous curve CL1. Subsequently, in step S60, the data for the second frame F2, which has undergone such correction, is returned from the server 20 to the client 10, and after the determination operation of step S70, step S40 is returned to once more.

The operations of these steps S40 through S70 are sequentially repeated, and correction is completed regarding all of the M number of frames.

Subsequently, in step S80, the client 10 reconstitutes the post-correction moving image by combining all of the post-correction frames Fi returned from the server 20. The client 10 generates a post-correction moving image by adding the sound information, which had been separated previously, to the visual information.

Here, in the correction performed by the server 20 in the above step S50, each frame Fi is corrected using the analysis results obtained by the client 10 in step S20 regarding the changes over time in the average value such that the average value of multiple frames Fi continuously changes. Therefore, variations and sudden changes in the value of the moving image MP can be prevented and correction can be performed such that the moving image MP becomes a natural image.

As described above, according to the moving image correction system 1 of this embodiment, the client 10 performs analysis of the moving image MP and the results of the analysis are sent to the server 20 over the network N. The server 20 then can perform correction using the analysis results obtained from the client 10. Therefore, the burden on the server 20 is reduced and the correction of the moving image can be effectively carried out.

In particular, where the moving image MP is divided and sent in units by the client 10 to the server 20 as described above, the processing burden on the server 20 can be further reduced. By performing transmission in units, concentration of the burden on the server 20 at any one time can be avoided, and even if requests for correction occur essentially simultaneously from multiple users, the benefit can be obtained that the processing by the server 20 is made efficient by performing processing for the multiple users in a so-called pipeline fashion.

The server 20 receives a data unit of the moving image MP from the client 10 after receiving data regarding changes over time in the moving image MP value preanalyzed by the client 10, and subsequently performs correction on that data unit. Therefore, the server 20 can perform flexible correction regarding each unit data using the analysis results. In other words, information regarding the change in value over time, which is lost when the image data is sent in units, is analyzed by the client 10 beforehand and sent to the server 20 before the image data is sent in units, this information can be used during the correction process. In particular, where the number of frames thinned out is large (i.e., where the interval between frames using which value analysis is performed is large), smooth changes in value can be obtained in the post-correction moving image through the performance of correction based on the information regarding the changes in value over time.

In the above embodiment, the situation was described in which one image frame, which is compressed using the JPEG format, is deemed the basic unit and the moving image is sent in these units, but it is also acceptable if unit-based transmission is carried out such that two or more (such as 15) frames are sent as a single unit.

<2. Second Embodiment>

In the first embodiment described above, the situation in which correction is performed regarding moving image data having the Motion JPEG format was explained, but in this second embodiment, a situation in which correction is performed regarding a moving image data having the MPEG format will be described.

The moving image correction system of this second embodiment has the identical construction to the moving image correction system of the first embodiment, and its processing sequence is also identical to that of the first embodiment. Differences will be mainly explained in the following description.

This second embodiment differs from the first embodiment in that the moving image MP, which is the object of correction, is an MPEG format file.

FIG. 9 is a drawing to explain the MPEG format file construction. A MPEG format file has minimum units (groups of pictures) compressed along the time axis. A group Gj, which is the minimum unit, comprises continuous frames that express a moving image during part of the period for the overall moving image, and includes information comprising image information regarding a single frame (a reference frame) that serves as a reference and information regarding differences from the reference frame. In this second embodiment, the situation in which the moving image is sent to the server 20 in units with these groups Gj as the basic units is used.

The sequence of operations conducted in the moving image correction system of this second embodiment is identical to the sequence of operations conducted in the first embodiment shown in the flow chart of FIG. 4. An explanation will be provided referring to FIG. 4 once more.

First, after user authentication is carried out in step S10, step S20 is performed.

In step S20, the client 10 analyzes the moving image MP, which comprises the object of correction.

Here, it is assumed that (1) the data format of the moving image MP is first determined to be the MPEG format as a result of the three analyses.

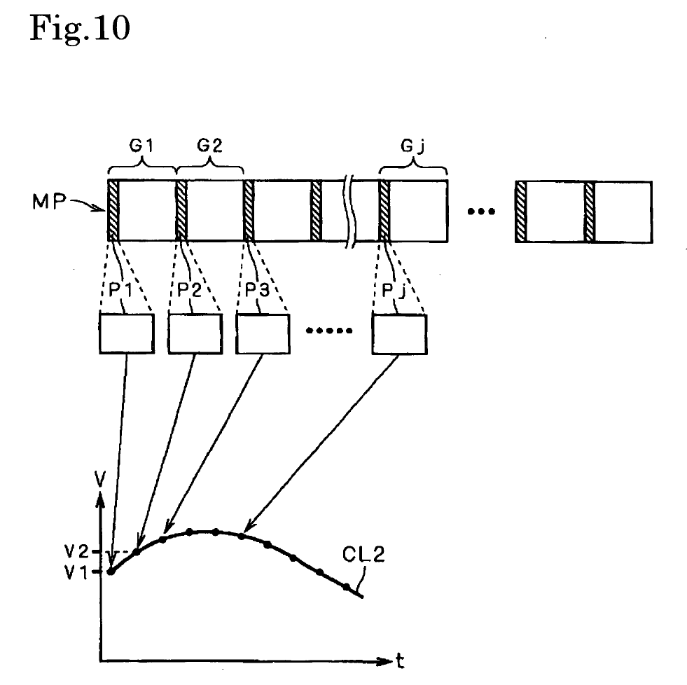

The analysis operation regarding (2) the changes in the average value over time in the moving image MP will now be explained. As shown in FIG. 10, the data having the MPEG format has multiple groups Gj, and each group Gj has a reference frame Pj. The analyzer 11 seeks the average value Vj of the tone values of the multiple pixels included in the reference frame Pj. This average value Vj can also be referred to as the average value of the reference frame. Here, this value Vj is sought for the reference frame Pj=1, . . . , L, where L represents the total number of groups) of each group Gj. It is also acceptable to seek the value Vj for each prescribed number of groups Gj in order to reduce the data amount and make the analysis operation more efficient. For example, the value Vj may be sought for odd-numbered groups only. In this case, the value Vj for groups Gj for which value Vj analysis was not performed can be sought via interpolation in step S50.

Here, (3) the number of units into which the moving image MP is divided, i.e., the number of units sent when the client 10 sends the moving image MP in units to the server 20, can be sought as the total number of groups L included in the moving image MP.

When the analysis operation described above is completed, the client 10 sends the above analysis results to the server 20 in the next step S30. This transmission data includes, in the same way as FIG. 7, (1) the command, (2) the data format of the moving image, (3) the changes over time in the average value, and (4) the number of units. For example, ‘the data format of the moving image’ is expressed by characters, symbols or the like that express that the data is in the MPEG format. The ‘changes over time in the average value’ are expressed as a row of numbers comprising the group number (j) and the value Vj corresponding to that group number.

The transmission data including the analysis results is sent from the analysis result sending unit 13 of the client 10 to the server 20, and is received by the analysis result receiving unit 23 of the server 20. These analysis results are used in the correction process performed in step S50.

In steps S40 through S70, such operations as transmission, correction and reply are performed for each unit of data of the moving image MP. In other words, the moving image MP is divided into units of data comprising multiple basic units, and is sent from the client 10 by basic unit. Here, the ‘group’, which is the smallest unit of the moving image MP, is used as the basic unit.

In step S40, the client 10 sends the data for each group Gj of the moving image MP to the server 20. Specifically, it first sends the first group G1 data.

In the next step S50, the server 20 that receives this group G1 data performs correction of this group G1 data based on the above-referenced analysis results. Specifically, it performs processing to adjust the color of the reference frame P1 based on the average value V1.

More specifically, the balance of the color components (R, G, B) is adjusted such that the post-correction average value Vb of the reference frame P1 continues to equal the value V1. The details of the processing are the same as in connection with the first embodiment described above.

The same processing is carried out regarding the frames Pd other than the reference frame P1 in the group G1. Specifically, the compressed information is expanded, the information regarding a frame Pd is obtained, and an adjustment is made to change the balance of the color components (R,G,B) while ensuring that the value Vd of that frame Pd equals the value (interpolated value) sought via interpolation using the value V1 and the value V2. The details of this processing are the same as those in connection with the reference frame P1, i.e., those in connection with the first embodiment. The post-correction data is compressed once more to reconstitute the group G1. Consequently, it becomes possible to correct the color of the group G1 while ensuring that the value of each frame after expansion changes along a continuous curve CL2.

In step S60, the server 20 returns the post-correction data to the client 10.

In step S70, the client 10 checks whether or not unit data (groups) to be sent to the serve 20 still remain. Specifically, the number of groups sent is counted, and the count result is compared with the total number of groups L. Where the number of groups sent is smaller than the value L, i.e., where unit data still remains to be sent, the operations of steps S40, S50 and S60 are repeated. On the other hand, where the number of groups sent equals the value M, i.e., where all unit data has been sent, the routine is ended.

By sequentially repeating the operations of the steps S40 through S70 for each group Gj, i.e., the second group G2 onward, correction can be completed regarding all of the M number of groups.

Subsequently, in step S80, the client 10 reconstitutes the post-correction moving image by combining all of the post-correction groups Gj returned from the server 20. The client 10 generates a post-correction moving image by adding the sound information, which had been separated previously, to the visual information.

Here, in the correction performed by the server 20 in the above step S50, each group Gj is corrected using the analysis results obtained by the client 10 in step S20 regarding the average value changes over time such that the average value of multiple groups Gj continuously changes. Therefore, variations and sudden changes in the value of the moving image MP can be prevented and correction can be performed such that the moving image MP becomes a natural image.

The same effect as that achieved in the first embodiment can be obtained through the second embodiment described above.

While the above description used the situation in which the image data is sent in units using the smallest units or groups Gj as the basic units, it is also acceptable if unit-based transmission is carried out such that two or more groups are sent as a single unit.

<3. Variations>

The above description explained the embodiments of the present invention, but the present invention is not limited to these embodiments, and may be implemented with various modifications.

For example, in the embodiments described above, ‘changes over time in the average value’ was used as an example of the changes over time in a prescribed characteristic of a moving image, but the present invention is not limited to this implementation. Other characteristics, such as chroma or hue, for example, may be used instead.

In addition, in the embodiments described above, the analysis results are returned to the server after the moving image is analyzed by the client, and the moving image is divided and sent in prescribed units, but it is possible to send the server the moving image data as a single block of data, particularly where large-capacity transmission is possible.

Furthermore, in the embodiments described above, an example in which the client 10 comprised a computer such as a personal computer was described, but the present invention is not limited to this implementation, and a cellular phone or other apparatus may be used as the client.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A moving image correction system that includes a client and a server that are mutually connected such that data communication is enabled therebetween over a network and in which the server processes a moving image sent from the client:
the client comprising;
an analyzing means that analyses a prescribed characteristic of the moving image to be corrected that changes over time,
an analysis result sending means that sends the results of the analysis performed by the analyzing means to the server over the network, and
a moving image sending means that sends the moving image to the server over the network, and
the server comprising;
a receiving means that receives the analysis results and the moving image sent from the client; and
a correcting means that corrects the moving image sent from the client based on the analysis results.

2. A moving image correction system according to claim 1, wherein the prescribed characteristic that changes over time with regard to the moving image analyzed by the client is value, such that the changes in value over time are analyzed, and the correcting means performs correction such that the value values obtained as a result of the analysis are essentially maintained.

3. A moving image correction system according to claim 1, wherein the prescribed characteristic that changes over time with regard to the moving image analyzed by the client is chroma, such that the changes over time in chroma are analyzed, and the correcting means performs correction such that the chroma values obtained as a result of the analysis are essentially maintained.

4. A moving image correction system according to claim 1, wherein the prescribed characteristic that changes over time with regard to the moving image analyzed by the client is hue, such that the changes over time in hue are analyzed, and the correcting means performs correction such that the hue values obtained as a result of the analysis are essentially maintained.

5. A movie correction system comprising a client and a server that are mutually connected such that data communication is enabled therebetween over a network:
the program used by the client including;
an analysis function to perform prescribed analysis of the movie to be corrected;
an analysis result sending function to send the analysis results obtained via the analysis function to the server over the network; and
a movie sending function to send the movie to the server over the network;
the program used by the server including
a receiving function to receive the analysis results and the movie sent from the client; and
a correcting function to correct the movie received via the receiving function using the analysis results.

6. A movie correction system according to claim 5, wherein the analysis function includes the analysis of the changes over time in a prescribed characteristic of the movie.

7. A movie correction system according to claim 5, the client program further includes a movie dividing function to divide the movie into multiple basic units, and the movie sending function sends the movie as a series of units.

8. A movie correction system according to claim 5, wherein the analysis results include information regarding the changes over time in a prescribed characteristic of the movie, and the correcting function has an image correction program that corrects the image data such that the characteristic values obtained as a result of the analysis may be maintained.

9. A movie correction system according to claim 5, the server program further includes a post-correction movie sending function to send the post-correction movie processed via the correcting function to the client over the network.

10. A movie correction system according to claim 7, wherein the server program according to the second aspect of the invention, the receiving function receives in basic units the movie divided into multiple basic units and sent from the client, and the correcting function individually performs correction of each of the multiple basic units using the analysis results.

11. A movie correction method for a system that includes a client and a server that are mutually connected such that data communication is enabled therebetween over a network,
(a) a step in which the client analyzes the movie to be corrected,
(b) a step in which the client sends the analysis results obtained in step (a) to the server over the network,
(c) a step in which the server receives the analysis results sent in step (b),
(d) a step in which the client sends the movie to the server over the network,
(e) a step in which the server receives the movie sent from the client, and
(f) a step in which the server corrects the received movie based on the analysis results.

12. A movie correction method according to claim 11, wherein the analysis function that performs analysis in step (a) analyzes the changes over time in a prescribed characteristic of the movie.

13. A movie correction method according to claim 12, wherein the step (d) when the movie is sent, it is sent as a series of multiple basic units into which it is divided.

14. A movie correction method according to claim 12, wherein the analysis results include information regarding the changes over time in a prescribed characteristic of the movie, and the step (f) that corrects the image data such that the characteristic values obtained as a result in step (a) may be maintained.

15. A movie correction method according to claim 12, wherein the prescribed characteristic of the movie analyzed in step (a) is value that changes over time, such that the changes over time in value are analyzed.

16. A movie correction method according to claim 12, wherein the prescribed characteristic of the movie analyzed in step (a) is chroma that changes over time, such that the changes over time in chroma are analyzed.

17. A movie correction method according to claim 12, wherein the prescribed characteristic of the movie analyzed in step (a) is hue that changes over time, such that the changes over tine in hue are analyzed.

18. A client-executed program used in a moving image correction system that includes a client and a server that are mutually connected such that data communication is enabled therebetween over a network, wherein the moving image sent from the client is corrected by the server,
An analyzing manager that analyzes a prescribed characteristic that changes over time with regard to the moving image to be corrected,
An analysis result sending manager that sends the analysis results obtained by the analyzing manager to the server over the network, and
A moving image sending manager that sends the moving image to the server over the network.

19. A client-executed program according to claim 18, the analyzing manager further includes the analysis of the compression/preservation format of the moving image.

20. A client-executed program according to claim 18, wherein the characteristic that changes over time and is analyzed by the analyzing manager is value.

21. A client-executed program according to claim 18, further including a moving image dividing manager to divide the moving image into multiple basic units, and the moving image sending function sends the moving image as a series of units.

22. A server-executed program used in a moving image correction system that includes a client and a server that are mutually connected such that data communication is enabled therebetween over a network, wherein the moving image sent from the client is corrected by the server, comprising
a receiving manager that incorporates the characteristic that correspond to the changes over time analyzed by the client regarding the moving image sent from the client,
an image receiving manager that incorporates the moving image sent from the client over the network, and
a correcting manager that corrects the moving image incorporated by the moving image receiving means using the analysis results.

23. A server-executed program according to claim 22, wherein the incorporated analysis results include information regarding the changes over time in the value of the moving image, and the correcting means corrects the image data such that the value information is essentially maintained.

24. A server-executed program according to claim 23, wherein the image receiving function incorporates the moving image that is divided into multiple basic units and is sent from the client such that the moving image is incorporated in basic units, and the correcting means individually corrects each of the multiple basic units using the analysis results.
